(19) United States
(12) Patent Application Publication
(10) Pub. No.: US 2003/0214413 A1
(43) Pub. Date: Nov. 20, 2003

(54) Apparatus and method for monitoring the pressure integrity of a piping system

(76) Inventors: John Henry Patterson, Vineyard Haven, MA (US); Benjamin Arnold, Sharon, MA (US)

Correspondence Address: JOHN HENRY PATTERSON, RFD SKIFFS LANE, VINEYARD HAVEN, MA, 02568, US

(21) Appl. No.: 10/151,452

(22) Filed: May 20, 2002

(51) Int. Cl. G08B 21/00

(52) U.S. Cl. 340/626

(57) ABSTRACT

An apparatus and methodology for continuously monitoring a statically pressurized piping system and providing an alarm signal if the system pressure integrity is compromised. The specific application considered is to monitor installed plumbing systems which are not in service or filled with water. Immediate detection of damage to these systems provides significant benefits to the user. The invention comprises a manifold with a means for sensing system pressure and provides an alarm signal if pressure falls below a pre-determined lower limit. The disclosed methodology suggests that a drop in system pressure is related to piping damage or leak that must be repaired. Once the source of the leak is located and repaired, the invention may be reset to provide additional monitoring.

### BACKGROUND

1. Field of the Invention

The present invention relates to an apparatus and method for continuously monitoring the integrity of a statically pressurized piping system. More particularly, the invention relates to the detection of damage to installed water piping systems during the construction of commercial and residential buildings.

2. Background Information

A problem of great concern in the plumbing trade is damage that may occur to various piping systems, in particular water piping systems, after their initial rough installation. Plumbing systems are installed early in the new construction process. After installation, rough plumbed piping systems are “capped” or sealed, filled with either air, water, or inert gas, and then pressure integrity tested to ensure that no leaks are present. This test is typically witnessed by the appropriate local plumbing inspector authority. After the pressure test, system pressure is typically relieved.

The plumbing contractor then leaves the job site while other trades continue to do construction work. Piping systems are routinely damaged during these ongoing construction activities resulting in breaches to piping system integrity. Leaks may also occur as a result of various material or workmanship deficiencies. As is the normal case, this condition is not discovered until the plumbing contractors return to the job site to perform the finish plumbing work and charge the piping systems with water, gas, or whatever medium the piping system will carry.

Since the piping system is already enclosed within the walls of the building at this point, repairing damage to the system can be difficult and very costly. Furthermore, because the leaks may be concealed, significant water damage may occur before the leak is detected. For example leakage often occurs at places that are not in view since the pipes are often hidden in walls, floors, and ceilings. Small leaks may drain into a building over a long period of time being absorbed in floors, ceilings or walls, giving rise to very expensive and extensive damage. Prior to the invention described here, water leaks have been detected in residential and commercial plumbing after the piping systems are installed and operating and not during the construction phase. At present, there is no method of adequately monitoring installed piping systems for damage during ongoing construction activities. By using the invention described here, any time an event occurred which impacted piping system integrity, all job site personnel would be notified immediately so that corrective action could be taken.

3. Description of Prior Art

A significant body of prior art exists in the fields of pressure testing and leak detection in piping systems. These are many sophisticated strategies for monitoring piping systems which are either “in service”, or specifically “under test”. Many of these systems incorporate pressure sensing as a component of their overall strategy.

U.S. Pat. No. 4,735,231 to Jacquet relates to an apparatus for sensing and stopping leakages between one or more tapping locations in a piping system. This apparatus is designed to monitor a system such that the water supply to the pipeline is closed off if a leak develops in the system. This system must compensate for fluctuating pressure conditions in the system (ie: pressure drop due to a flushed toilet can not be mis-interpreted as a system leak) so as not to turn the supply off without cause. This apparatus is comprised of many components and is overly complicated for the current application. Further, the stop valve would not offer an advantage in the referenced application because there is no supply of water to the system.

Other patents, such as U.S. Pat. No. 5,190,069 to Richards utilize various electronic sensors to identify pipe leaks (integrity failures) by detecting the presence of water in specific household locations. One disadvantage of these devices is that are only useful after the piping systems have been charged with water and are in operation. Another disadvantage is that a separate sensor is required at each potential leak point in the system to be effective. These sensors must be permanently installed and maintained to ensure proper operation.

U.S. Pat. No. 6,244,100 to Hastings describes an apparatus for detecting a leak in a temporarily isolated segment of a pipe. The apparatus and methodology include mechanisms for producing and measuring the response of pressure pulses in the pipe to determine if any leakage exists. The primary disadvantage of this approach is that leaks are detected only at the time that the test is performed. If a leak develops it will not be detected until the next test cycle. Another disadvantage of this approach is that it requires sophisticated calculations involving transit time of pressure pulses and the effects of small changes in system temperature (in a closed system, static pressure will change with ambient temperature changes).

U.S. Pat. No. 5,621,164 to Woodbury et al. discloses a system and methodology for detecting combustible gas leaks. This apparatus includes a pressure switch coupled to a warning alarm. The apparatus requires a specific sequence of shutoff valve operations to isolate various piping segments for the test. One disadvantages of this apparatus is that it is only effective during the actual test cycle. Another disadvantage is that this approach requires a costly, permanent installation of all system apparatus for each application. Another disadvantage is that system maintenance is required because if any component of the apparatus should fail to operate properly, test results could be compromised.

The prior art in the field of monitoring the pressure integrity of piping systems does not provide an adequate solution to the problem described in the background information section of this application. Previous approaches suffer from one or more of the following disadvantages:

a) the apparatus is only effective for systems that are “in service”.

b) the apparatus must be permanently installed and maintained for each application.

c) the apparatus requires multiple access points to provide monitoring for a complete system.

d) the component and installation cost of the apparatus is high.

e) the method of operation only produces results during a specific test sequence or time period.

f) the method of operation requires complex calculations or sequencing operations.

g) the method of operation does not provide for immediate detection of piping system integrity failures.

Objects and Advantages of the Current Invention

Besides the objects and advantages of the prior art in piping system monitoring and leak detection, several advantages of the present invention are:

a) to provide an economical apparatus to alert personnel of an integrity failure in a piping or plumbing system under static pressure conditions.

b) to provide a monitoring apparatus that is easily transportable from one location to another.

c) to provide a monitoring apparatus that is portable and does not require a permanent installation.

d) to provide a method for immediately detecting damage to rough plumbed piping systems during the construction phase of a building or residence.

e) to provide a method whereby an entire piping system can be monitored from a single point within the system.

f) to provide a method of operation which is simple to understand and implement.

g) to provide a method which allows damaged piping to be repaired immediately, before being hidden by finished construction activities.

h) to provide a method which results in constant monitoring of piping system integrity, requiring no activation or sequencing operations once a test has started.

### SUMMARY

In accordance with the design objects of the invention, there is provided an apparatus for monitoring the pressure integrity of a closed static piping system comprising: a manifold body with a bore, a connection for connecting the bore to the piping system, a sensor for measuring the pressure within the bore, and an alarm connected to the pressure sensor for indicating when pressure within the bore drops below a pre-defined limit.

In accordance with the operational objects of the invention, there is provided a method for detecting an integrity failure (leak) in a closed static piping system comprising:

a) attaching an apparatus to the piping system, the apparatus comprising a manifold body with a bore, a connection for connecting the bore to the piping system, a sensor for measuring the pressure within the bore, and an alarm connected to the pressure sensor for indicating when pressure within the bore drops below a pre-defined lower set-point limit.

b) pressurizing the piping system and the apparatus manifold bore using an appropriate pressurization system.

c) verifying that the pressure level in the piping system and the manifold bore exceeds the pre-defined lower set-point limit of the pressure sensor and;

d) activating or “arming” the apparatus such that the audible alarm will sound if the pressure within the manifold bore drops below the pre-defined lower set-point limit.

### DRAWING FIGURES

FIG. 1 is a side view of the assembled integrity monitor.

FIGS. 2A and 2B show details of the integrity monitor manifold.

FIG. 3 is a detail view of the housing base.

FIGS. 4A and 4B show component and assembly views of the housing cover.

FIG. 5 is a wiring schematic for the device.

### DETAILED DESCRIPTION OF THE INVENTION

Reference will now be made to the drawings in which the various elements of the present invention will be given numeral designations and in which the invention will be discussed so as to enable one skilled in the art to make and use the invention.

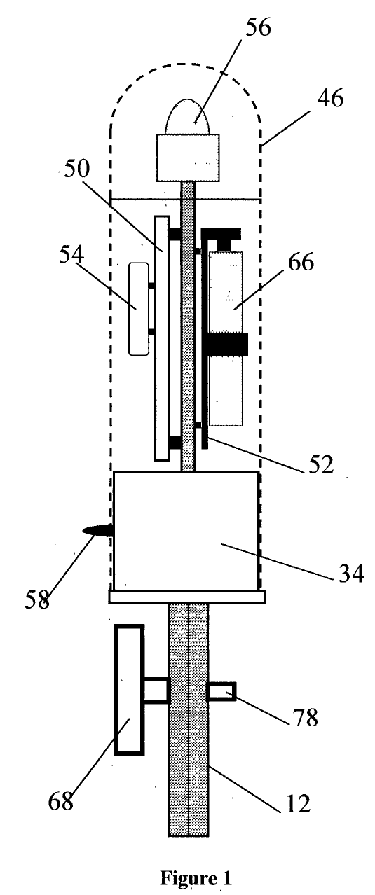

A preferred embodiment of the fully assembled Integrity Monitor is shown in FIG. 1. The primary structural component of the device is a manifold body 12, which supports and provides connections to the other system components. A pressure switch 56, is connected to one end of manifold 12. At the other end of the manifold a threaded connection (not shown) is provided for attaching the monitor to a piping system. A back mounted pressure gauge 68 for indicating system pressure is connected to the side of the manifold 12. Connected opposite the pressure gauge 68 is an air inlet valve 78. Valve 78 is a standard air pressure valve such as used for pressurizing automobile tires.

Also shown mounted to manifold body 12 in FIG. 1 is a circuit board 50. Mounted to the circuit board 50 is an audible alarm device 54. A clip 52 for holding a power source is also attached to manifold 12. The preferred power source is an industrial grade 9-volt battery 66, which fits securely into clip 52. A housing base 34 attaches to manifold 12 and provides a mounting connection for a housing cover 46 (shown in phantom lines). A manual switch 58 for arming and testing the device is also secured to the housing base 34.

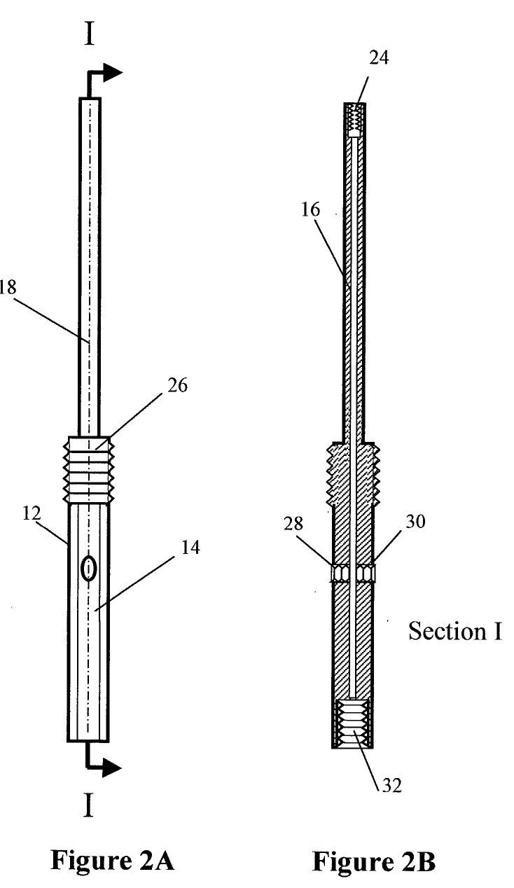

FIG. 2A is a view of manifold body 12 of the Integrity Monitor showing a lower body 14 and an upper body 18. Manifold body 12 is preferably machined from 1-inch hexagonal brass stock, but may be made of other similar materials. The exterior of the lower body 14 of manifold 12 is maintained as a hexagonal shape to provide a surface for using a standard pipe wrench for installing or removing the device to or from a piping system. At the top of the lower body 14, an external ¾″ NPT connection 26 is provided for connecting the manifold body to a housing base (not shown). The exterior of the upper body 18 of manifold 12 is machined flat on both sides to reduce width and to provide mounting surfaces for the system circuit board and battery clip as shown in FIG. 1. Reducing the width of the upper body of the manifold is required so that it can slide through the threaded hole in the housing base during assembly. The circuit board and the battery clip may be secured to the flat surfaces of the manifold upper body 18 by a variety of methods, preferably by providing threaded mounting holes in the upper manifold body, mating holes in the circuit board and battery clip, and appropriate fasteners.

FIG. 2B is a cross-sectional view of manifold 12 along direction I-I shown in FIG. 2A. This view shows a longitudinal bore 16, which runs the length of the manifold body. An internal threaded connection 24 is provided at the top of the manifold upper body for connecting the pressure switch shown in FIG. 1 to the manifold and to bore 16. A second internal threaded connection 28 is provided in the lower manifold body to attach a pressure gauge to the manifold and bore 16. Directly opposite connection 28 a third internal threaded connection 30, is provided for connecting an air inlet valve to the manifold and bore 16. A fourth internal threaded connection 32 is provided at bottom of the manifold lower body and bore 16. This connection 32 is used to attach the monitoring device to a piping system under test. Connections 24, 28, and 30 are specified as ⅛″ NPT connections; connection 32 is specified as ¾″ NPT.

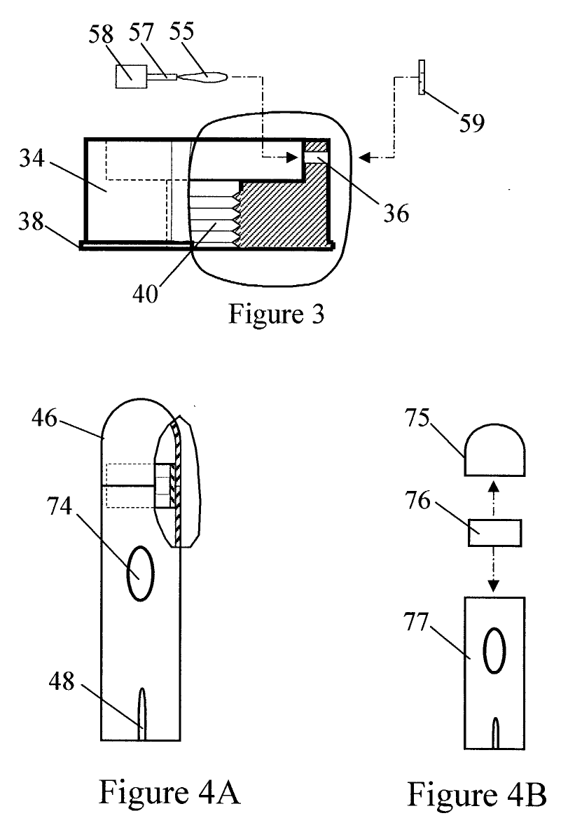

FIG. 3 is a detail view of housing base 34 with an integral flange 38. The preferred construction of the housing base is a ¾ inch×2 inch PVC reducing bushing. This bushing is a standard plumbing component. Housing base 34 has an outside diameter for mating with a housing cover (not shown) is connected. The housing cover slides onto the base and seats against flange 38. The housing may be held in place by friction, or by the use of a securing screw (not shown). The cutaway section of FIG. 3 reveals that the housing base has an internal threaded connection 40 for securing the base 34 to the external threaded portion 26 of the lower body 14 of manifold 12 shown in FIG. 2A. The housing base also has a drilled hole 36 for mounting manual switch 58. Switch 58 has a threaded shank 57 and an actuation lever 55. Lever 55 and shank 57 pass through hole 36 in the housing base. Switch 58 seats against the inside surface of the housing base and is held in place by securing capture nut 59 onto shank 57.

FIG. 4A shows a assembled housing cover 46 that is installed onto the housing base 34 once the internal components of the apparatus have been assembled. The cover has a slot 48 to permit manual switch 58 mounted in base 34 as shown in FIG. 3 to be exposed. The cover also has a sound hole 74 so that the audible alarm signal is not impeded. Care must be used in assembly of the housing cover to the device assembly shown in FIG. 1 to ensure that the housing sound hole 74 is aligned to the audible alarm device.

FIG. 4B shows the preferred construction of cover 46 as an assembly of standard 2″ diameter PVC plumbing components consisting of; a high-pressure sleeve 77, an end cap 75, and a short piece of connector piping 76. The outside diameter of connector 76 fits snugly to the inside surfaces of sleeve 74 and cap 75. The components of the housing cover are permanently glued together to form a single unit as shown in the cutaway section of FIG. 4A.

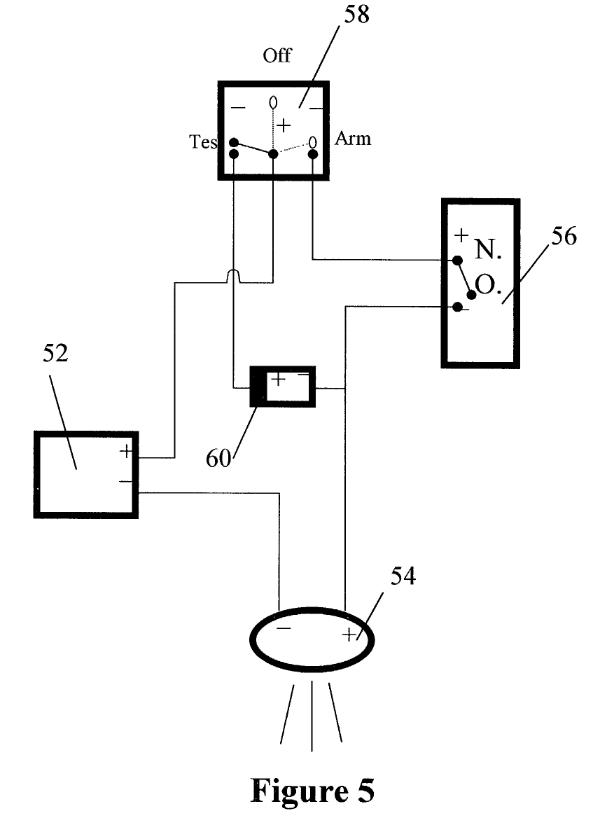

FIG. 5 is a circuit diagram indicating the system electrical components and preferred wiring connections for system operation. The preferred components include the 9-volt battery power source 52, a three-position on/off/(on) manual switch 58, a normally closed (NC) pressure switch 56, an audible alarm device 54, and a zener diode 60. In the preferred embodiment, audible alarm 54 and diode 60 are permanently mounted to circuit board 50 shown in FIG. 1. The other components of the electrical circuit are affixed to either manifold 12 or housing base 34 as shown in FIGS. 1 and 3. The audible alarm 54 may be any device which is compatible with the requirements and objectives of the invention. The preferred alarm is a piezo-electric design, has a low current draw when coupled to a 9 volt battery, and generates a sound level of at least about 100 db. Pressure switch 56 is normally closed (NC) and has an adjustable activation setpoint. The electrical contacts within switch 56 are closed when subjected to pressures below the activation setpoint and open at pressures above this setpoint. When manual switch 58 is in the on or “arm” position, current flows through switch 58 to pressure switch 56. If switch 56 is closed (low pressure condition) current then flows to the alarm 54 and produces a loud alarm signal. When switch 58 is placed in the (on) or “test” position as shown in FIG. 5, current flows from switch 58 through a zener diode 60 (8.7V, 500 mW) to alarm 54, bypassing pressure switch 56. Diode 60 is used to reduce the voltage level resulting in a lower alarm volume for the system “test”. The (on) or “test” position is used to verify that the system battery and alarm are charged and functional. When switch 58 is in the off position, no power is available to the audible alarm. Note that the parenthetical (on) in the description of switch 58 designates that the “test” position is momentary contact only—the manual switch will remain in the (on) position only while it is held in place.

Additional embodiments of the electronics of this device could include a pressure sensor with a digital readout and alarm circuit, or a normally open pressure switch instead of normally closed one. These would not impact the overall functionality of the device. Another embodiment could include a clocking function such that a user could easily determine the start time for a given test or the actual time of an alarm event. Yet another embodiment could include an additional apparatus to dial a telephone or paging system in the event of an alarm condition such that personnel not present on the job site could be notified of a problem.

Operation

To operate the leak detection device, the user first connects the assembled apparatus to a sealed piping system that is to be monitored. An external ¾″ NPT connection must be provided in the piping system for this attachment. Pressurized air from an air compressor or hand pump is then introduced through the inlet valve 78, thus charging the manifold bore 16 and the piping system. The pressure gauge 68 indicates the pressure level in the piping system. The preferred pressure for system testing is 60 psig. Once the piping system and manifold bore 16 have been fully pressurized, the system is armed or turned on. If the pressure in the manifold bore then drops below the pre-defined activation set point of pressure switch 56, the switch will close causing the alarm to sound. The preferred activation setpoint for pressure switch 56 is 40 psig. It is important to set the test pressure a minimum of 30% higher than the low pressure set-point to allow for variations in piping system pressure that will occur as the ambient temperatures fluctuate. Calculations show that a temperature change of 100 degree F. could create a pressure change of as much as 20% in a typical residential plumbing system charged with air.

Once activated, the alarm will continue to sound until the device is turned off manually, or until the battery is drained. It is recommended that users employ the “test” mode of the device for battery power at regular intervals to ensure that a leak event does not go undetected.

If an alarm event occurs, the source of the leak must be identified and repaired. The apparatus must then be reset to continue monitoring the repaired piping system. Once the piping system is ready to be put into service, the device in this application is no longer used for leak detection. The device can be removed from the piping system and re-used in another location.

Conclusions, Ramifications, and Scope

Thus the reader will see that the Integrity Monitor invention provides an economical and easy to use solution to a longstanding problem in the plumbing and construction industries. By using the methods described, a single monitor provides an alarm signal if any portion of a closed piping system incurs an integrity failure. Failures can be repaired immediately, resulting in significant savings in both piping repair costs and potential water damage. The Monitor can be re-used over and over on various job sites with little maintenance or additional cost.

Additional Ramifications

While the description above contains many specifications, these should not be construed as limitations to the scope of the invention but rather as an illustration of one presently preferred embodiment of the invention. Significant variations in the embodiment of the device could be used to achieve the same results—some examples include:

1) Connection types specified are preferred due their standard usage in the plumbing industry. Other connection styles could be substituted into the design.

2) Use of alternate power sources (additional or other types other batteries, solar power, 120 VAC power etc,) could be considered.

3) Use of alternate or additional alarm types such as visual alarms and/or telephony systems to notify off-site personnel of an alarm event.

4) Use of a N.O. (normally open) pressure switch mechanism.

5) Use of a pressure sensor and switching circuit instead of a simple pressure switch device.

6) Adding a digital display for pressure readout.

7) Use of different materials or configurations for the device housing.

8) Use of different mounting configurations for system components within the preferred housing design.

9) Adding a timing device such that the elapsed test time or the time of an alarm event could be displayed and recorded.

The method of operation of the apparatus could also be extended for use in piping systems which are statically pressurized with mediums other than air. These could include water, oil, or any other suitable fluid or gas.

Thus the scope of the invention should be determined by the appended claims and their legal equivalents, rather than the examples given.

What we claim is:

1. An apparatus for continuously monitoring the pressure integrity of a closed piping system comprising:
a manifold body with a bore, a connecting means to provide a sealed connection between said bore and said piping system, a means to sense a pressure level within the bore, and an alarming means to generate an alarm signal if said pressure level within said bore is lower than a predetermined low level set point,
whereby said alarm will provide notification that the piping system integrity has failed.

2. The apparatus of claim 1 wherein the apparatus includes a pressure display means for indicating the pressure in the bore.

3. The apparatus of claim 1 wherein the manifold body has a second connection for connecting an external pressurization system to the manifold bore.

4. The apparatus of claim 1 wherein the means for sensing pressure is a pressure switch.

5. The apparatus of claim 1 wherein the means for sensing pressure is a sensor providing a continuous and variable output signal proportional to system pressure.

6. The apparatus of claim 1 further including a clocking means such that the elapsed time of said monitoring activities or the time of occurrence of said low pressure alarm activation may be displayed.

7. The apparatus of claim 1 wherein the apparatus has a multiple-position switch capable of alternately arming the apparatus or testing the alarm.

8. The apparatus of claim 1 wherein the alarming means is an audible alarm signal.

9. The apparatus of claim 1 wherein the alarming means is a visual warning light.

10. The apparatus of claim 1 wherein the alarming means includes a means to notify remotely located personnel if an alarm condition occurs.

11. A method for continuously monitoring the pressure integrity of a closed static piping system comprising:
a) attaching an apparatus to the piping system, the apparatus comprising a manifold body with a bore, a connecting means to provide a sealed connection between said bore and said piping system, a means to sense a pressure level within the bore, and an alarming means to generate an alarm signal if the pressure level within said bore is lower than a predetermined low level set point,
b) pressurizing the piping system and the apparatus manifold bore using an appropriate pressurization means,
c) verifying that the pressure level in the piping system and the manifold bore exceeds the pre-defined lower set-point limit of the pressure sensor and;
d) activating or “arming” the apparatus such that the alarm will activate if the pressure within the manifold bore drops below the pre-defined lower set-point limit.

12. The method of claim 11 wherein the pressure sensing means is a pressure switch which triggers at a preset low level of pressure within said bore.

13. The method of claim 11 wherein the pressure sensing means is a sensor providing a continuous and variable output signal proportional to system pressure.

14. The method of claim 11 wherein pressurization means is a source of compressed air.

15. The method of claim 11 wherein the alarming means is an audible alarm signal.

16. The method of claim 11 wherein the alarming means is a visual warning signal.

17. The method of claim 11 wherein the alarming means includes a means to notify remotely located personnel if an alarm condition occurs.

18. The method of claim 11 further including a pressure display means for indicating the pressure within said bore.

19. The method of claim 11 further including a clocking and display means such that the elapsed time of said monitoring activities or the time of occurrence of said low pressure alarm activation may be displayed.

20. An apparatus for continuously monitoring the pressure integrity of a closed piping system comprising:
a manifold body with a bore, a ¾″ NPT connection to provide a sealed between said bore and said piping system, a pressure switch to sense a pressure level within the bore, and an audible alarm signal if said pressure level within said bore is lower than a predetermined low level set point,
whereby said alarm will provide notification that the piping system integrity has failed.
